(19) United States
(12) Patent Application Publication
(10) Pub. No.: US 2025/0091650 A1
(43) Pub. Date: Mar. 20, 2025

(54) SIDE PART FOR A MOTOR VEHICLE BODY

(71) Applicant: BENTELER AUTOMOBILTECHNIK GMBH, Paderborn (DE)

(72) Inventors: Georg FROST, Steinheim (DE); Christian HIELSCHER, Delbrueck (DE); Andreas HITZ, Erwitte (DE); Paul KAUPMANN, Anroechte (DE); Mathias LOHBERG, Altenbeken (DE); Joern TOELLE, Paderborn (DE)

(21) Appl. No.: 18/884,891

(22) Filed: Sep. 13, 2024

(30) Foreign Application Priority Data
Sep. 14, 2023 (DE) 102023124893.6

(51) Int. Cl. B62D 25/04; B62D 21/15; B62D 25/16; B62D 29/00

(52) U.S. Cl. CPC B62D 25/04; B62D 25/16; B62D 29/007; B62D 21/15

(57) ABSTRACT

A rear side part of a motor vehicle body, has a C pillar, a D pillar and a wheel housing segment, and is produced as a one piece sheet metal forming part in a press stroke. The C pillar and the D pillar being C-shaped, U-shaped or hat-shaped in cross-section, characterized in that the side part includes adjacent areas with different tensile strengths and/or different wall thicknesses.

### RELATED APPLICATIONS

The present application claims priority of German Application Number 10 2023 124 893.6 filed Sep. 14, 2023, the disclosure of which is hereby incorporated by reference herein in its entirety.

### FIELD

The present disclosure relates to a rear side part for a motor vehicle body.

### BACKGROUND

Engines are used in motor vehicles and automobiles so as to drive them. These engines are able to be combustion engines, but also electric drives.

These motor vehicles, also known as automobiles, have a self-supporting body. Such a self-supporting body is made from individual metal components, e.g., steel components. Also, aluminum components are used. The individual components of the self-supporting body are individually manufactured, i.e., an A pillar, B pillar, C pillar, a longitudinal beam, a cross beam, a bow or wheel housing, and subsequently assembled, joined together, or welded. This embodies the self-supporting body. The individual components are manufactured as press-formed components.

A side wall for a motor vehicle manufactured as a press-formed component is described in DE 10 2020 119 869 A1 and DE 10 2011 089 436 A1.

The object of the present disclosure is to demonstrate a way of providing a body component which is able to be produced efficiently and inexpensively in terms of manufacturing technology, but which at the same time improves crash performance and thus occupant safety and rigidity.

### SUMMARY

Therein, a rear side part of a motor vehicle body is described. This side part includes a C pillar, a D pillar and a wheel housing segment or wheel housing section. The side part is manufactured as a one-piece sheet metal forming part, for example, in a press stroke. The side part has adjacent areas with different tensile strengths and/or different wall thicknesses.

“One piece” means a sheet metal forming part that is either cut out of a one piece metal sheet of uniform material and then formed in a press stroke. Alternatively, “one piece” for the purposes of the present disclosure means a component blank that is produced prior to forming, press forming or deep drawing, for example as a tailored welded blank or tailored rolled blank. According to the present disclosure, a large component is produced in its outer dimensions in one press stroke with one press movement. This means that individual components such as the C pillar, D pillar, wheel housing segment and wheel arch do not have to be produced; instead, the component is produced in one piece in a single press stroke. This increases the precision of the manufactured component. On the other hand, production resources are reduced, which means lower production costs.

In at least one embodiment of the present disclosure, the rear side part is a steel component that is manufactured as a hot-formed and press-hardened component. This means that different strength values are able to be set in relation to the strength, e.g., the tensile strength Rm. Solid areas have a tensile strength RM greater than 1000 MPa, whereas high-tensile areas have a tensile strength greater than 1350 MPa. In the present disclosure, soft areas have a tensile strength of less than 1000 MPa, less than 850 MPa, or between 500 and 850 MPa.

For the purposes of the present disclosure, a reinforcement patch is able to be applied locally. The reinforcement patch is applied prior to the forming.

In addition to the freedom of forming, at least one of the pillars, i.e. the C pillar and/or the D pillar itself, is or are C-shaped, U-shaped or hat-shaped in cross-section. The wheel housing segment itself is a large-scale sheet metal component, which is contoured after the forming process as an arched freeform. In a lower area in relation to the vertical direction of the vehicle, a wheel arch is arranged on the wheel housing segment. For the purposes of the present disclosure, the wheel housing segment is also able to partially form an inner side wall of the vehicle body in an upper area of the wheel housing segment itself in the vertical direction of the vehicle, so that a part of the wheel housing is only formed in the lower area of the wheel housing segment and the corresponding wheel housing segment is only formed in this lower area with a partial spherical orientation.

In at least one embodiment of the present disclosure, the wheel housing segment in the area of the wheel arch itself has an L-shaped configuration in cross-section, so that an L-shaped leg is arranged to protrude outwards during an installation scenario. In at least one embodiment of the present disclosure, a higher tensile strength and/or an increased wall thickness in relation to the remaining areas of the wheel housing segment is in the area of the wheel arch.

According to the present disclosure, the area of the C pillar is also formed with a higher tensile strength and/or wall thickness, so that the tensile strength is greater than 980 MPa, greater than 1000 MPa, or greater than 1200 MPa.

The wheel arch itself has a semi-circular circumferential configuration and extends over an angular range greater than 30 degrees, greater than 45 degrees, or greater than 60 degrees.

Furthermore, a front area is able to be formed in the wheel housing segment or on the wheel arch in the longitudinal direction of the vehicle in such a way that a sill connection is provided, the sill connection in turn having a higher tensile strength and/or wall thickness compared to the remaining area of the wheel housing segment. This increases the rigidity of the vehicle body, e.g., for straight-line driving during operation, but also in the event of a crash.

The sheet metal blank to be initially provided and subsequently processed is a tailored welded blank. The tailored welded blank is produced by laser welding. The joined areas between the C pillar and the D pillar, or between the C pillar and the wheel housing segment, or between the D pillar and the wheel housing segment are then formed as butt joints and are welded using laser welding.

Alternatively or in addition, or in a mixed form, the individual aforementioned connection points, i.e. between the C pillar and the D pillar, between the C pillar and the wheel housing segment, and between the D pillar and the wheel housing segment, are also able to be at least partially overlapping and produced, for example, by spot welding. What they have in common, however, is that the component blank or sheet metal blank produced in this way is made in one piece and is placed together in a large forming press, known as a Giga Press, and the entire rear side part is then formed in one press stroke. This means that individual components do not have to be formed and later joined together, but the entire rear side part assembly is formed in one press stroke in one press tool.

### BRIEF DESCRIPTION OF THE DRAWINGS

Further advantages, features, properties and aspects of the present disclosure are the subject of the following description. Various embodiments are shown in schematic figures. These serve to facilitate understanding of the present disclosure. In the drawings:

FIG. 1 shows a first embodiment of a rear side part with partial cross-sectional views,

FIG. 2 shows an alternative embodiment to FIG. 1, with butt joint laser-welded seams of the component blank,

FIG. 3 shows an alternative embodiment to FIG. 2, with overlapping areas on the component blank, and

FIG. 4 shows a lateral view of an alternative embodiment of a rear side part.

### DETAILED DESCRIPTION

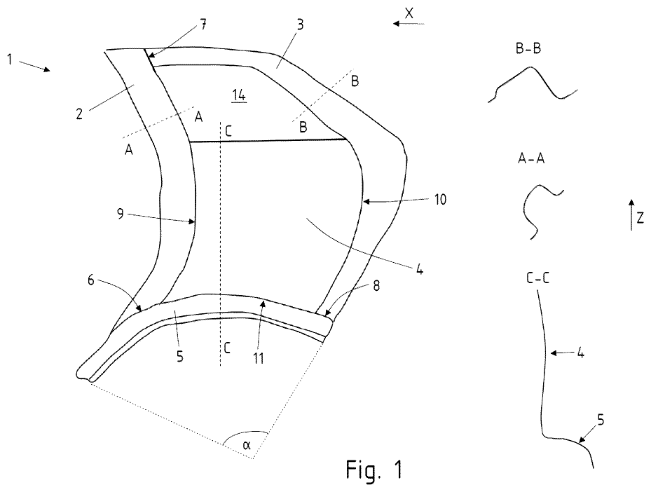

FIG. 1 shows a side wall 1 of a motor vehicle with the respective partial sectional views. This refers to the rear side wall 1 in the longitudinal direction x of the vehicle. The side wall 1 includes a D pillar 3, which also forms the upper roof frame area, and a wheel housing segment 4. The wheel housing segment 4 includes a wheel arch 5 in a lower area in relation to the vehicle's vertical direction z. The entire component is produced in one piece from a sheet metal blank in one press stroke. The respective partial cross-sectional view according to the sectional line A-A shows that the C pillar 2 itself is hat-shaped in its cross-section, with flanges protruding therefrom. The partial cross-sectional view along the sectional line B-B shows that the cross-section of the D pillar 3 is C-shaped or U-shaped. The cross-sectional view, according to sectional line C-C, shows that the wheel housing segment 4 has a protruding leg in a lower area and is therefore L-shaped in cross-section or, due to the slight curvature, has a spherical section shape or is contoured as an arched freeform. The wheel arch 5 protrudes outwards and thus provides geometric reinforcement.

In relation to an angle α, the wheel arch 5 is formed with a circumference of more than 30°, more than 45°, or more than 60° or in the shape of a circular arc section. The individual transition areas are shown here on the component blank, which then leads to the forming of the entire rear side part 1, as butt-jointed and laser-welded tailored welded blanks. In at least one embodiment of the present disclosure, the transition area 6 between the C pillar 2 and the wheel arch 5 or the wheel housing segment 4 is shown. Also shown is the transition area 7 between the D pillar 3 and the C pillar 2, as well as a transition area 8 between the D pillar 3 and the wheel arch 5. Also, a respective transition area 9 between the C pillar 2 and the wheel housing segment 4, as well as a transition area 10 between the wheel housing segment 4 and the D pillar 3 is able to be formed. These are also able to be formed as tailored welded blanks.

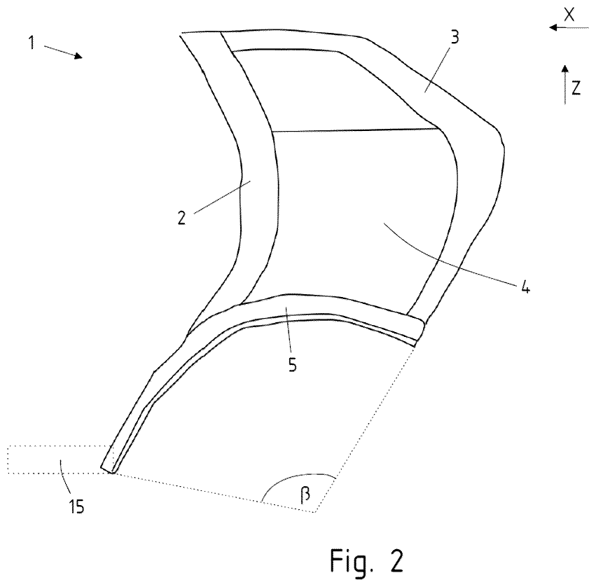

In at least one embodiment of the present disclosure, a greater wall thickness for the C pillar 2 is able to be used, or also for the D pillar 3 compared to the wheel housing segment 4. The wheel arch 5 itself is able, again, also be attached to the wheel housing segment 4 with a transition area 11, in which case, again, a blunt laser weld seam would be formed over the entire length of the transition area. This means that the wheel arch 5 is able to also have a greater wall thickness than the rest of the wheel housing segment, but less than the wall thickness of the C pillar. By selecting different steel grades with different hardenability and/or corresponding tailored tempering before, during or after hot forming, the tensile strengths are able to also differ accordingly. A greater wall thickness and/or higher tensile strength is in the upper area of the C pillar 2 than in the lower area of the C pillar, and/or than in the wheel housing segment. In the area of the D pillar 3, an equal or lesser tensile strength, or lower tensile strength is selected for an equal or lower wall thickness compared to the C pillar 2. However, the D pillar 3 itself is formed with a greater wall thickness and greater tensile strength in relation to the wheel housing segment 4. The same applies to the wheel arch 5. The D pillar 3 is also able to be equipped with a greater wall thickness and/or greater tensile strength on the finished component than the remaining area of the wheel housing segment. In the transition or connection areas 9 and 10, the C pillar 2 and the D pillar 3 each extend over a large part in the vertical direction z of the vehicle, and thus also form side areas of the wheel housing segment 4. In at least one embodiment of the present disclosure, the C pillar 2 and the D pillar 3 would then not only be in an upper area in which a windshield frame or a windshield 14 would be inserted. FIG. 2 shows an alternative embodiment to FIG. 1. Here, the wheel arch 5 is extended and extends over a larger angular range β than shown in FIG. 1. Here, an extension of the wheel arch 5, in the longitudinal direction x of the vehicle and in the vertical direction z of the vehicle, is formed here in such a way that an indicated sill 15 of a vehicle body is able to be coupled. In this example, too, the upper area of the C pillar 2 is formed with a greater wall thickness, while the large flat area of the wheel housing segment 4 has the thinnest wall thickness. The wheel arch 5 is formed with a wall thickness that ranges between the greatest wall thickness of the C pillar and the wall thickness of the flat area of the wheel housing segment. The wheel arch 5 and at least the upper area of the C pillar 2 are hardened. The D pillar 3 has a lesser wall thickness than the C pillar 2, but a greater wall thickness than the wheel housing segment 4. Hardening is able to be achieved by tailored tempering, so that the tensile strength is adjusted in a hot forging hardening process, or by using steel grades that are able to be hardened to different degrees in the tailor welded blank. The hardened areas have a tensile strength greater than 1,000 MPa.

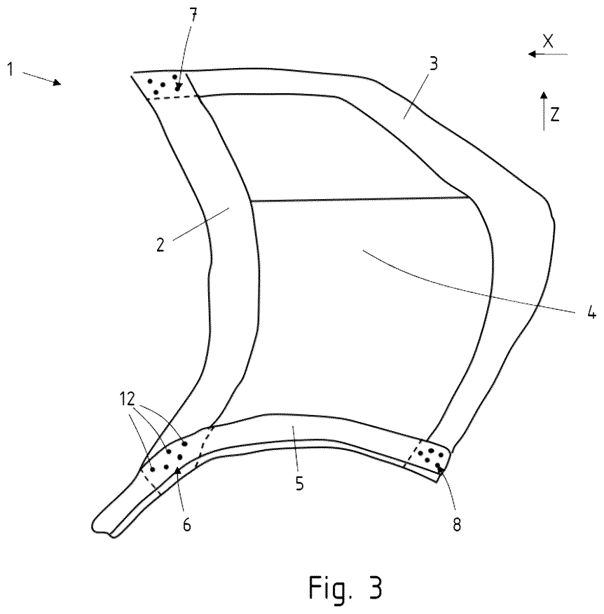

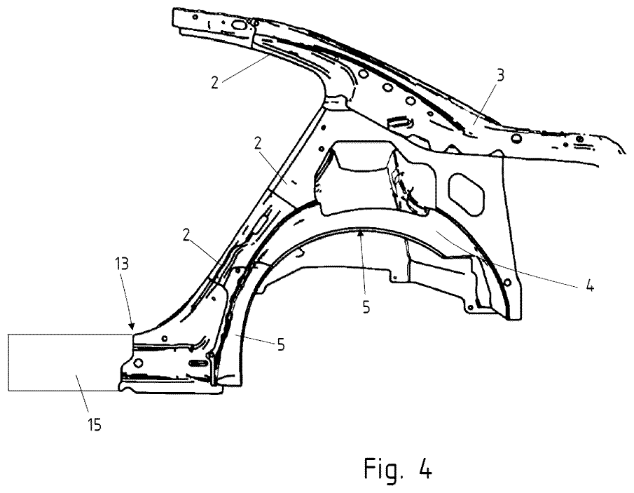

FIG. 3 shows an alternative embodiment. Here, an overlap is formed in the respective transition areas 6, 7 and 8, i.e. produced with the component blank in such a way that the transition areas form a double layer. These are then connected by means of spot welds 12, which are indicated here. This tailored welded blank with overlaps is also produced in one press stroke, so that the entire rear side part is produced as a one piece component. FIG. 4 shows an alternative embodiment of a rear side part 1, and also has a C pillar 2 and a D pillar 3. The C pillar 2 has a hat-shaped or U-shaped cross-section. A lesser wall thickness is formed in the area of the D pillar 3. The least wall thickness is in the area of wheel housing segment 4. A large wall thickness is formed in the area of the C pillar 2, as well as in the wheel housing and in the sill connection area 13.

An upper section of the C pillar 2 has a wall thickness of >1.6 mm and a tensile strength of >980 MPa. A patch is also able to be provided as an option.

A lower area of the C pillar 2 has a wall thickness of 1.2 mm to 1.6 mm and a tensile strength of >980 MPa from approximately the wheel arch height. The same characteristic values apply to the D pillar 3.

The wheel arch 5 has a wall thickness of >1.6 mm and/or a tensile strength of >980 MPa, >1,350 MPa, and is hardened.

In the area of the wheel housing segment 4, between the C pillar 2, the D pillar 3 and the wheel arch 5, a wall thickness of 0.8 mm to 1.6 mm, and/or a tensile strength <1,350 MPa, <980 MPa is formed.

The steel grades used are able to be used as examples below and are able to be used for all variants of the present disclosure. In the present disclosure, different steel grades are able to be combined with each other in a tailored welded blank. Corresponding ranges of tensile strengths for hard or soft areas, or high-tensile or ductile areas are able to be found in the table. All alloy components are given in wt %, with the rest of the iron and impurities resulting from the melting process being added to the respective hardenable steel alloy.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

| 1 | | C | | Si | | Mn | | P | | S | |
|---|---|---|---|---|---|---|---|---|---|---|---|
| 2 | TWB section from | min | max | min | max | min | max | min | max | min | max |
| 3 | hardenable steel >1300 MPa | 0.19 | 0.25 | 0.1 | 0.4 | 1.1 | 1.4 | | 0.02 | | 0.005 |
| 4 | 22MnB5 Rm approx. 1500 MPa | 0.2 | 0.23 | 0.2 | 0.3 | 1.1 | 1.4 | | 0.02 | | 0.005 |
| 5 | hardenable steel >1750 MPa | 0.31 | 0.37 | 0.1 | 0.6 | 1 | 1.5 | | 0.025 | | 0.02 |
| 6 | 34MnB5 Rm approx. 1900 MPa | 0.33 | 0.35 | 0.15 | 0.35 | 1 | 1.5 | | 0.025 | | 0.015 |
| 7 | ductile steel >450 MPa | 0.06 | 0.13 | | 0.7 | | 1.9 | | 0.05 | | 0.05 |
| 8 | hardenable ductile steel 800-1000 MPa | 0.07 | 0.11 | 0.02 | 0.6 | 1.2 | 1.8 | | 0.03 | | 0.01 |
| 1 | | Al | | B | | Cr | | Cu | | N | |
| 2 | TWB section from | min | max | min | max | min | max | min | max | min | max |
| 3 | hardenable steel >1300 MPa | 0 | 0.06 | 0.004 | 0.1 | | 0.3 | | 0.1 | | |
| 4 | 22MnB5 Rm approx. 1500 MPa | 0 | 0.06 | 0.004 | 0.1 | 0.1 | 0.3 | | 0.1 | | 0.01 |
| 5 | hardenable steel >1750 MPa | | 0.1 | 0.001 | 0.004 | 0.08 | 0.35 | | 0.2 | | 0.2 |
| 6 | 34MnB5 Rm approx. 1900 MPa | 0.01 | 0.08 | 0.001 | 0.004 | 0.08 | 0.5-Mo | | 0.2 | | 0.2 |
| 7 | ductile steel >450 MPa | | 0.1 | | 0.003 | | 0.15 | | 0.2 | | 0.2 |
| 8 | hardenable ductile steel | 0.01 | 0.07 | 0.0007 | 0.002 | | 0.15 | | 0.2 | | 0.2 |
| 1 | | Nb | | Ni | | Ti | | V | | Mo | |
| 2 | TWB section from | min | max | min | max | min | max | min | max | min | max |
| 3 | hardenable steel >1300 MPa | | 0.05-Ti | 0.02 | 0.1 | 0.01 | 0.1 | | | | 0.35 |
| 4 | 22MnB5 Rm approx. 1500 MPa | | 0.05-Ti | 0.02 | 0.1 | 0.02 | 0.05 | | 0.01 | | 0.35 |
| 5 | hardenable steel >1750 MPa | | 0.1 | | 0.2 | 0.002 | 0.05 | | | | 0.35 |
| 6 | 34MnB5 Rm approx. 1900 MPa | 0.01 | 0.06 | | 0.2 | 0.005 | 0.015 | | 0.01 | | 0.5-Cr |
| 7 | ductile steel >450 MPa | | 0.1 | | | | 1.2 | | 0.1 | | 0.1 |
| 8 | hardenable ductile steel 800-1000 MPa | 0.04 | 0.1 | | | 0.03 | 0.2 | | 0.1 | | 0.1 |

1-11. (canceled)

12. A rear side part of a motor vehicle body, the rear side part comprising:
a C pillar, a D pillar, and a wheel housing segment, manufactured as a one piece sheet metal forming part in one press stroke,
wherein the C pillar and the D pillar are C-shaped, U-shaped or hat-shaped in cross-section,
wherein the rear side part has adjacent areas with at least one of different tensile strengths or different wall thicknesses.

13. The rear side part according to claim 12, being a hot-formed and press-hardened component.

14. The rear side part according to claim 12, wherein a high-tensile area of the rear side part has a tensile strength greater than or equal to 1350 MPa.

15. The rear side part according to claim 12, wherein a low-tensile area of the rear side part has a tensile strength of less than 1000 MPa.

16. The rear side part according to claim 12, further comprising a reinforcement patch applied at least locally to the C pillar.

17. The rear side part according to claim 12, wherein the wheel housing segment is contoured in the shape of a partial sphere or a spherical segment, or the wheel housing segment is contoured in an L-shape in cross-section in an area of a wheel arch.

18. The rear side part according to claim 12, wherein the wheel housing segment has at least one of a lower tensile strength or an increased wall thickness in an area of a wheel arch.

19. The rear side part according to claim 18, wherein the wheel arch has a semi-circular configuration and extends over an angular range greater than 30°.

20. The rear side part according to claim 12, wherein the one piece sheet metal forming part is manufactured from a tailored welded blank used as sheet metal blank.

21. The rear side part according to claim 12, wherein the C pillar has a first section with a tensile strength >1,350 MPa, and a second section with a tensile strength of <1,000 MPa.

22. The rear side part according to claim 12, wherein the C pillar, the D pillar and the wheel housing segment enclose an opening.
